(19) United States
(12) Patent Application Publication
(10) Pub. No.: US 2010/0147231 A1
(43) Pub. Date: Jun. 17, 2010

(54) Electrolytic Cell for an Internal Combustion Engine

(76) Inventors: Timothy Donald Bogers, Keswick (CA); Joseph C. Williams, Winnipeg (CA)

Correspondence Address: ADE & COMPANY INC., 2157 Henderson Highway, WINNIPEG, MB, R2G1P9, CA

(21) Appl. No.: 11/911,150

(22) PCT Filed: Mar. 27, 2006
(86) PCT No.: PCT/CA06/00454

§ 371 Date: Nov. 24, 2009

Related U.S. Application Data
(60) Provisional application No. 60/748,161, filed on Dec. 8, 2005.
(60) Provisional application No. 60/671,526, filed on Apr. 15, 2005.

(51) Int. Cl. F02B 43/08

(52) U.S. Cl. 123/3

(57) ABSTRACT

An electrolyser system produces combustion enhancing gas for communication with the intake of an internal combustion engine. An anode and a cathode are supported spaced apart from one another in a chamber filled with electrolytic solution with the cathode and the anode being nearest one another adjacent a bottom end of the chamber to concentrate the electrolysis activity adjacent the bottom end of the chamber. The electrolysis activity is therefore not significantly affected by varying levels of solution in the chamber. The anode comprises a plurality of independent units with respective independent power supplies. An amperage control selectively connects and disconnects the power supplies with the respective independent units of the anode for adjusting applied amperage across the solution and accordingly for varying the production rate of combustion enhancing gas responsive to engine demands.

### FIELD OF THE INVENTION

The present invention relates to an electrolytic cell for use with an internal combustion engine, and more particularly relates to an electrolyser system using an electrolytic cell to produce gases for enhancing combustion in the engine.

### BACKGROUND

It is known that the addition of hydrogen and oxygen gas to an internal combustion engine enhances combustion by reducing noxious emissions and improving mileage. It is further known that hydrogen and oxygen gases can be readily produced by electrolysis of water in an onboard electrolyser for a vehicle. Various related examples of electrolytic cells are listed in the following patents: U.S. Pat. No. 6,311,648 (Larocque), U.S. Pat. No. 4,875,988 (Aragon), U.S. Pat. No. 41,966,086 (Scoville), U.S. Pat. No. 5,178,118 (Nakamats), U.S. Pat. No. 4,368,696 (Reinhardt), U.S. Pat. No. 5,711,865 (Caesar), U.S. Pat. No. 4,627,897 (Tetzlaff et al), U.S. Pat. No. 4,111,160 (Talenti), U.S. Pat. No. 6,257,175 (Mosher et al.), U.S. Pat. No. 3,915,834 (Wright et al.), U.S. Pat. No. 4,442,801 (Gynn et al.), U.S. Pat. No. 4,196,068 (Scoville), U.S. Pat. No. 6,804,949 (Andrews et al.), U.S. Pat. No. 6,857,397 (Zagaja et al.), U.S. Pat. No. 6,464,854 (Andrews et al.), and Canadian patent 2,349,508. In general the prior art use of electrolysers are either far too complex to manufacture at a reasonable cost or pose certain safety risks due to the potential for explosions. Many are inefficient and do not feed the combustion enhancing gases produced by the electrolyser to the engine in an efficient or reliable manner.

Furthermore, most known structures of anodes and cathodes are not well suited for production of combustion enhancing gases at a reliable rate or at a controllable rate as required by some specific applications, for example when used with an internal combustion engine on a vehicle with varying fuel demands. Common construction in prior art electrolytic cells involves upright orientation of the anodes and cathodes at a consistent spacing along the length thereof or horizontally extending anodes and cathodes positioned along a full height of the cell so that electrolysis is intended to occur substantially evenly along a full height of the cell. As the solution is consumed by the cell however, the resulting fluid level in the cell will vary and will greatly affect the performance of the cell due to the varying contact of the fluid with the working surfaces of the anode and cathode, making it difficult to accurately control the rate of gas production of the cell. Furthermore, when mounted on a vehicle, simply the motion of the vehicle will tend to cause the fluid level in the cell to vary and accordingly also cause the rate of gas production of the cell to vary.

The known construction of anodes and cathodes of the electrolytic cells include many deficiencies as well. Anodes and cathodes which are formed of a solid catalyst like nickel for example, suffer from degradation due to a small amount of carbon which is typically present in the nickel which is extracted during the electrolytic process. Other catalytic materials are very expensive and accordingly not suitable for mass production.

### SUMMARY OF THE INVENTION

According to one aspect of the invention there is provided an electrolyser system for producing combustion enhancing gas for an internal combustion engine, the system comprising:

an enclosed housing having a chamber for containing electrolyte solution;

an anode and a cathode supported spaced apart from one another in the chamber of the housing;

a gas conduit for conducting gas from the chamber of the housing to the engine;

a power source having opposed terminals for connection to the anode and cathode respectively; and

the cathode and the anode being nearest one another adjacent a bottom end of the chamber.

The construction of the anode and cathode is particularly advantageous when providing working portions nearest one another adjacent the bottom of the chamber as the fluid levels are maintained sufficiently high to fully cover the working portions where most electrolysis occurs even when the fluid level drops or varies due to consumption of the solution or movement of the solution responsive to vehicle movement supporting the electrolyser system thereon. Accordingly, the rate of gas production of the electrolyser system can be accurately controlled as the rate remains consistent throughout varying solution levels to maximize efficiency of production of combustion enhancing gases for a vehicle internal combustion engine.

Preferably both the anode and the cathode comprise a perforated member of steel having a nickel plating formed thereon.

The cathode and the anode may each comprise a working portion in which the working portions span generally horizontally spaced above one another adjacent a bottom end of the chamber at a uniform spacing.

Each anode and each cathode also preferably comprises connecting portions extending upwardly from all sides and at opposed ends of the respective working portion in which the connecting portions of the anode and the cathode having increasing spacing therebetween with increasing distance from the bottom end of the chamber so as to be spaced farther apart from one another adjacent the top end of the chamber. Preferably the anode is nested within the cathode and the connecting portions of the anode are tapered inwardly towards one another. Accordingly, the working portions are preferably nearer to one another than the connecting portions.

The connecting portions preferably serve both to be anchored between the working portion and a top end of the chamber and for communicating the working portion with the power source through the cap when the chamber comprises a seamless bottom and side walls enclosed at a top end by the cap.

The working surface area of the cathode is preferably at least 20% greater than a working surface area of the anode.

There may be provided a low fluid level sensor supported within the chamber adjacent a lower prescribed limit of the chamber which is arranged to detect a level of fluid reaching the prescribed limit by detecting disconnection of a ground connection of the low fluid level sensor with the electrolyte solution in the chamber.

There may also be provided a high fluid level sensor supported within the chamber adjacent an upper prescribed limit of the chamber which is arranged to detect a level of the fluid reaching the prescribed limit by detecting connection of a ground connection of the high fluid level sensor with the electrolyte solution in the chamber.

The fluid level sensors are preferably centrally supported within the cap of the housing.

There may be provided a safety switch arranged to interrupt connection of the power source to at least one of the anode and the cathode responsive to an abnormal orientation of the engine, for example a vehicle roll over.

In one embodiment there is provided a refill reservoir coupled to the chamber by a fill conduit for replenishing the electrolyte solution in the chamber from the refill reservoir through the fill conduit.

There may be provided a coolant bypass conduit for connection to the internal combustion engine to receive coolant fluid from the engine therethrough in which the coolant bypass conduit is coupled to one or more of the housing, the fill conduit or the refill reservoir for exchanging heat with the coolant fluid received through the coolant bypass conduit. Preferably the coolant bypass conduit surrounds the fill conduit such that the fill conduit is received substantially concentrically through the coolant bypass conduit along a length of the fill conduit.

In an alternative embodiment, there is provided a fill spout coupled to the housing for receiving electrolyte solution therethrough to fill the chamber to a prescribed maximum fluid operating level. Preferably the fill spout includes an open top end which is selectively enclosed by a cap in which the open top end, is at a height which is substantially in alignment with the prescribed maximum fluid operating level.

Preferably the housing is arranged for mounting below an intake of the engine such that the gas conduit extends continuously upward from the housing to the engine intake.

According to a further aspect of the present invention there is provided an electrolyser system for producing combustion enhancing gas for an internal combustion engine, the system comprising:

an enclosed housing having a chamber for containing electrolyte solution;

an anode and a cathode supported spaced apart from one another in the chamber of the housing;

a gas conduit for conducting gas from the chamber of the housing to the engine;

a power source having opposed terminals for connection to the anode and cathode respectively; and

an amperage control for adjusting amperage supplied by the power source to the anode and cathode.

Providing a power supply which is capable of adjusting the amperage supplied to the anode and cathode permits the rate of production of combustion enhancing gases to be controllably varied, for example to meet varying fuel demands in a vehicle internal combustion engine. More particularly, amperage supplied to the anode and cathode can be adjusted by shutting down one of multiple anode or cathode units and a respective power supply associated therewith for further optimizing efficiency. By providing a common cathode with multiple independently operated anode units having respective power supplies within a common fluid bath, failure of one unit does not affect operation of the other units for also optimizing dependability of the system.

Preferably the power source comprises a plurality of independent power supplies and the amperage control is arranged to connect and disconnect the power supplies with at least one of the anode and the cathode independently of one another to adjust amperage supplied to the cathode and the anode.

There may be provided a plurality of load sensing switches connected to the engine to determine respective prescribed operating conditions of the engine in which each prescribed operating condition corresponds to a different fuel demand by the engine. The load sensing switches are preferably associated with respective ones of the power supplies which are only connected to both the anode and the cathode responsive to determination of the prescribed operating condition by the associated load sensing switch.

The amperage control may be arranged to adjust amperage responsive to varying pressure in a turbocharger of the engine. In this instance, the prescribed operation condition of the engine corresponds to a turbocharger pressure.

When the anode comprises a plurality of independent units, the amperage control may be arranged to vary a submerged surface area of the anode by connecting and disconnecting the independent units with the power source independently of one another.

Preferably the power source comprises a plurality of independent power supplies associated with the independent units respectively and the amperage control selectively connects and disconnects the plurality of independent power supplies with respective ones of the plurality of independent units to adjust amperage supplied to the anode and cathode responsive to a prescribed operating condition of the engine.

The cathode preferably comprises a common unit spanning the plurality of independent units of the anode.

Preferably the independent units of the anode are identical in configuration with one another so as to be interchangeable.

Some embodiments of the invention will now be described in conjunction with the accompanying drawings in which:

### BRIEF DESCRIPTION OF THE DRAWINGS

FIG. 1 is a schematic view of an engine incorporating the electrolyser system.

FIG. 2 is a schematic view of the controller and power supplies of the electrolyser system shown in greater detail.

FIG. 3 is a flow chart illustrating the operation of the electrolyser system.

FIG. 4 is a perspective view of a first embodiment of the electrolyser housing.

FIG. 5 is a top plan view of the housing according to FIG. 4 shown with the cover removed.

FIG. 6 is a sectional view along the line 6-6 of FIG. 5.

FIG. 7 is a sectional view along the line 7-7 of FIG. 5.

FIG. 8 is a partly sectional side elevational view of the cap shown removed from the housing according to FIG. 4.

FIG. 9 is a bottom plan view of the cap of FIG. 8.

FIG. 10 is a sectional elevational view of an alternative embodiment of the anode construction for use with the housing according to FIG. 4.

FIG. 11 is a schematic view of an alternative embodiment of the refilling system for use with the housing according to FIG. 4.

FIG. 12 is a perspective view of an alternative embodiment of the housing surrounded by a jacket.

FIG. 13 is an end view of the jacket of FIG. 12.

FIG. 14 is a top plan view of the jacket of FIG. 12.

FIG. 15 is a sectional view along the line 15-15 of FIG. 12.

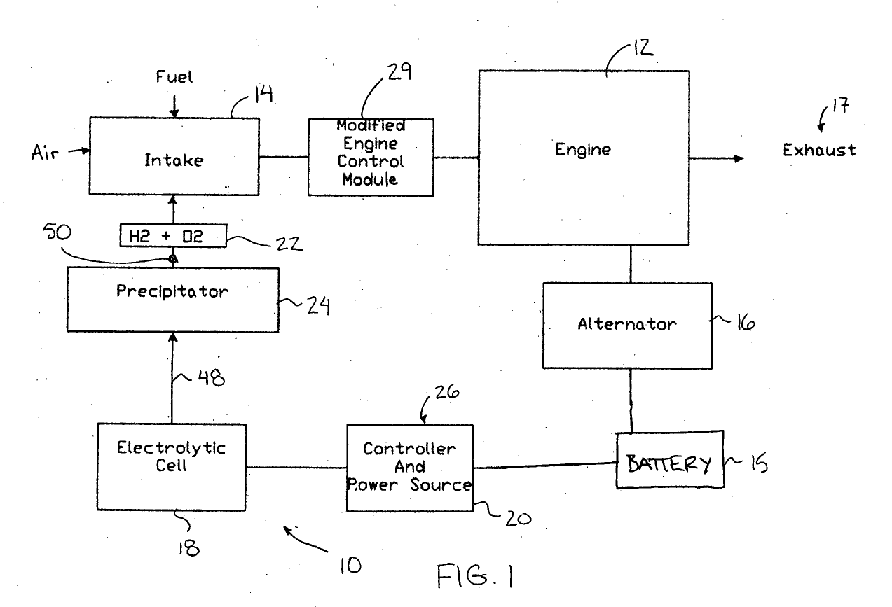

In the drawings like characters of reference indicate corresponding parts in the different figures.

### DETAILED DESCRIPTION

Referring to the accompanying figures there is illustrated an electrolyser system generally indicated by reference numeral 10. The system 10 is particularly suited for producing combustion enhancing gases for an internal combustion engine 12. Although various embodiments are shown in the accompanying Figures, the common features will first be described herein.

The engine 12 typically receives fuel from an onboard supply which is received through the intake 14 of the engine. Electrical power is generated by an onboard alternator 16 which is coupled to the engine. Generated electrical power or energy is stored in a battery 15. Combustion of the fuel within the engine produces exhaust 17.

The electrolyser system 10 comprises an electrolytic cell 18 which receives power from a power source 20 which will be described in further detail below. The power source 20 receives power from the battery 15 and converts the power to a DC current which has been transformed to a range suitable for use by the electrolytic cell by a transformer incorporated into the power source.

The cell 18 is arranged for electrolysis of water to produce hydrogen and oxygen gases 22 which are commonly fed together to the intake 14 of the engine after passage through a liquid precipitator 24 in series between the outlet of the electrolytic cell and the engine intake to remove any liquid carried by the gas prior to entering into the engine intake. The cell is arranged for mounting below an intake of the engine such that the gas conduit between the cell and the intake extends continuously upward from the cell to the engine intake. In the common fluid bath of the cell, water is mixed with an effective amount of a suitable electrolyte, for example potassium hydroxide (KOH), so that the resulting solution resists freezing in colder climates.

The power source 20 is provided with a controller 26 which controls connection of the power source with the cell for selectively interrupting power to the cell to turn the cell off when desired or to vary the operating conditions of the cell.

The controller 26 includes an engine operating sensor 28 comprising a probe in the engine for detecting operation of the engine to ensure that the cell is only powered on when the engine is turned on. The engine operating sensor 28 comprises either an electrical switch for determining that the alternator of the engine is generating electrical power or a pressure switch for determining that oil pressure is present in the engine.

The controller 26 also includes a safety switch 27 coupled in series with the engine operating sensor 28. The safety switch 27 comprises a motion detector capable of detecting a vehicle roll over or other abnormal or non-upright vehicle orientations and the like. The safety switch 27 thus determines if an unsafe condition occurs during and subsequent to which the cell should not be operating. The cell thus only receives electrical power if certain prescribed safety conditions are met as determined by the engine operating sensor 28 and the safety switch 27. The safety conditions may thus include ensuring that the alternator 16 is delivering electrical power, that oil pressure is present in the engine or that the vehicle is not in an inverted, abnormal or otherwise unsafe orientation.

The system also includes a modified engine control module 29 which replaces an existing engine control module associated with the engine upon installation of the system 10 on a vehicle. The modified engine control module 29 makes use of various sensors on the vehicle for monitoring various vehicle conditions including exhaust emissions for example and for determining the optimum rate of production of combustion enhancing gases for the cell to be operated at. The modified engine control module 29 accordingly works in cooperation with the controller 26 of the system 10.

The controller further includes a mid-load switch 30 which is arranged to be closed when sensing a more elevated operating condition of the engine corresponding to greater fuel demand as compared to initial start-up or idle. A high-load switch 32 is optionally also provided which detects a second elevated operating condition greater than the first operating condition detected by the mid-load switch 30 and which corresponds to further increased fuel demands by the engine. Further switches corresponding to yet further increased engine demands may be provided as desired.

The mid-load switch 30 and the high-load switch 32 are arranged to determine fuel demands of the engine by being responsive to pressure in a turbocharger of the vehicle. The mid-load switch 30 is accordingly closed when a first elevated pressure condition occurs in which pressure of the turbocharger is greater than at idle. Furthermore, the high-load switch 32 is closed when a second elevated pressure condition occurs in which pressure of the turbocharger is greater than at the first elevated pressure condition.

The controller 26 also ensures that the cell is only operated with a proper operating fluid level within the cell by providing a low fluid level sensor 34 and a high fluid level sensor 36. Each of the fluid level sensors 34 and 36 comprises a ground connection supported within the chamber within the cell 18 for selective contact with the electrolytic solution through which the sensor is grounded.

The low fluid level sensor 34 projects downwardly from the top of the cell 18 to a free end of the sensor which terminates near the bottom end of the cell, corresponding to a prescribed lower limit which is the lowest desired operating fluid level of the cell. Thus as long as the fluid remains above this lower limit, the sensor 34 remains in contact and is grounded within the electrolytic solution in the cell. As the level falls below the level sensor 34, the ground connection of the sensor is broken and disconnected from the solution so that the controller 26 can detect if the fluid level is too low when the ground connection of the level sensor 34 is disconnected.

The high fluid level sensor 36 similarly comprises a probe extending downwardly from the top of the cell 18 to a bottom free end of the sensor defining a ground connection which terminates at an upper limit corresponding to the highest desirable fluid operating level. During normal operating conditions, when the cell is only partly full of electrolytic solution, the ground connection of the high fluid level sensor 36 remains disconnected from the electrolytic solution. As the fluid level is raised and reaches the high fluid level sensor 36, the ground connection of the sensor is connected with the fluid or solution in the cell 18 so that the controller 26 senses if the fluid has reached the upper limit by detecting when the sensor 36 becomes grounded.

The low and high fluid level sensors each comprise a rod which is nickel plated similarly to the cathode and anode using an electroless plating process.

The cell 18 comprises an enclosed housing having a solid body 38 formed of an ultrahigh molecular weight (UHMW) plastic material, or another insulating material, which includes a bored out cavity 40 formed therein from the open top end of the body. The cavity 40 defines a main electrolytic chamber within the housing having no seams about the bottom or side walls to ensure that no electrolytic fluid contained therein is permitted to leak out of the chamber. The bottom and side walls of the chamber are all formed integrally with one another to form a suitable, seamless receptacle for retaining fluid therein. The body 38 is generally rectangular in shape having greater longitudinal and lateral dimensions in the horizontal direction than the height of the body.

The housing includes a cap 42 which is also formed of UHMW plastic material having a similar length and width as the body 38 but being shorter in height for enclosing the open top end of the cavity 40 across which it spans. The cap is secured to the body 38 by a plurality of bolts 43 extending fully through the body 38 and cap 42 from the bottom of the cell to the top of the cell when the cap is assembled onto the body. The bolts 43 are located at spaced positions about a full periphery of the cap and body.

The cap 42 includes a recess 44 formed in a bottom side thereof which is centrally located and which is much smaller in dimension than the lateral and longitudinal dimensions of the interior of the cavity 40 in the body. The interior walls forming the recess 44 within the cap taper downwardly and outwardly to the lower peripheral edge thereof to ensure that any condensate formed thereon readily drips back downwardly into the cavity in the body.

A gasket is provided for spanning about a periphery of the body 38 at the top end for abutment with the underside of the cap 42 to form a perimeter seal at the seam between the cap and the body.

The cap 42 also includes a gas outlet 46 extending through the top side thereof for communication with the recess 44 where the produced gas from the cell 18 collects prior to exiting through the gas outlet 46. The gas outlet 46 connects to the intake of the engine by a gas conduit 48. The conduit 48 typically comprises an open connection when the intake is not pressurized above atmospheric pressure. However, when the engine intake operates under pressure, for example when a turbocharger is present, a check valve 50 is coupled in series with the gas conduit 48 to prevent fuel from being forced back into the electrolyser by the engine intake operating pressure.

A rupture disc 51 is also mounted on the cap in communication by a respective passage with the interior chamber of the cell. The rupture disk comprises a membrane of nickel and Teflon which is arranged to rupture when pressure in the cell exceeds a maximum pressure, for example in the order of 77 or 78 psi. When the rupture disc 51 is ruptured, pressure is vented from the cell to prevent a possible explosion or the like in the event of a blow back of pressure from the vehicle intake for example. The rupture disc 51 also prevents further operation of the cell until proper maintenance is performed on the cell.

A pressure relief valve 52 is also mounted on the cap 42 for communication with the recess 44 in the cap to vent excess pressure, for example 5 to 20 psi, when the electrolyser is operating at an unsafe condition.

The gas outlet 46, the pressure relief valve 52 and the fluid level sensors 34 and 36 are all centrally located in the cap for communication therethrough. Centrally locating these items in the cap ensures that solution which splashes up the sides of the chamber walls during vehicular motion do not significantly affect proper operation of these items.

The cell 18 includes a cathode 54 and an anode 56 supported commonly within the chamber defined by the cavity 40 within the housing of the cell. The anode 56 comprises a plurality of independent units 57 which are commonly supported within the chamber of the cell 18 with a single common member forming the cathode. Voltage is applied across the cathode and anode to produce a current therebetween through the solution within the housing which in turn induces reaction of H₂0 into hydrogen and oxygen gases.

Each of the anode and cathode are formed of sheeted stainless steel material which is perforated and which includes an electroless nickel plating thereon. The electroless nickel plating is accomplished by dipping the anode and cathode in a nickel/phosphor bath with no electricity for a prescribed time frame based upon chemical concentrations that determine the thickness of the plating.

The cathode 54 includes a working portion 58 comprising a generally horizontally spanning plate which covers the full bottom of the flat bottomed cavity 40 within the cell. The cathode also includes connecting portions 60 in the form of vertical extending side walls connecting between the working portion 58 and the open top end of the cavity 40 on all four sides of the rectangular shape of the working portion 58. The connecting portions 60 line the interior of the side walls defining the cavity 40.

Some of the connecting portions 60 of the cathode are in the form of an upright wall which acts as a baffle portion 62 fully spanning between opposing side walls of the cavity 40 and spaced between opposing ends to form a divider between an adjacent pair of the units 57 of the anode. All of the portions of the cathode are formed of the same sheeted material which is perforated so that the baffle portions 62 permit the electrolytic solution to flow therethrough. The baffle portions thus act only to limit fluid movement but not fully restrict the flow of fluid thereacross.

Terminal connectors 64 extend upwardly from the connecting portions 60 in the form of a rigid rod extending upwardly through the cap member once the cap is secured to the body for external connection to the power source 20 via the controller 26. The connectors 64 are provided at spaced positions about the periphery of the cell, at opposing longitudinal ends for optimizing flow across a full length of the cathode 54 between the opposed longitudinal ends of the cell.

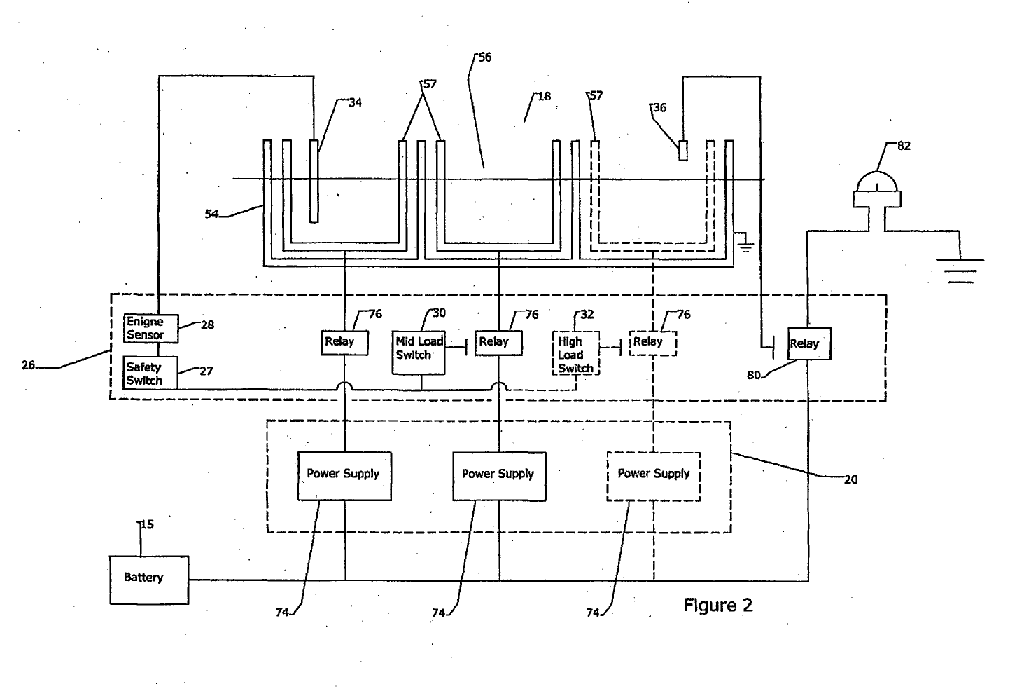

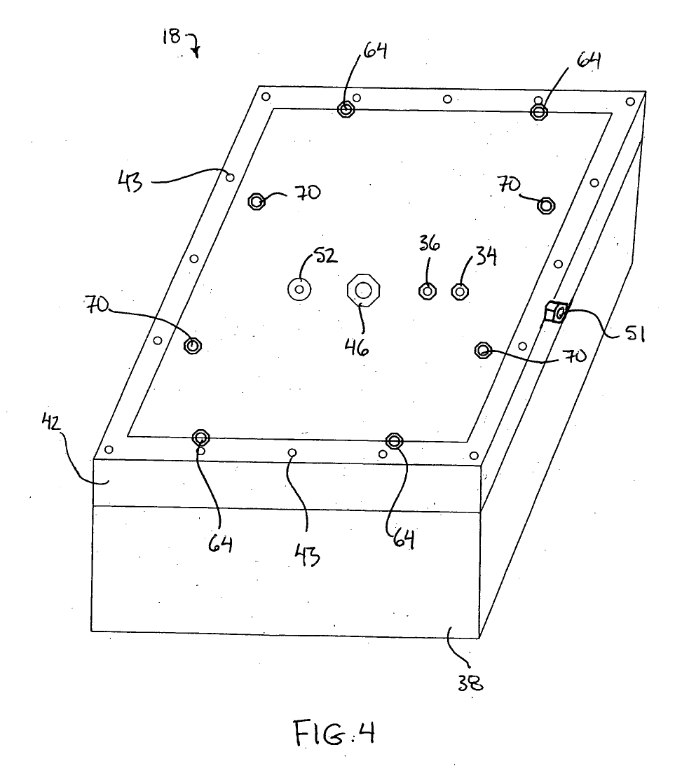

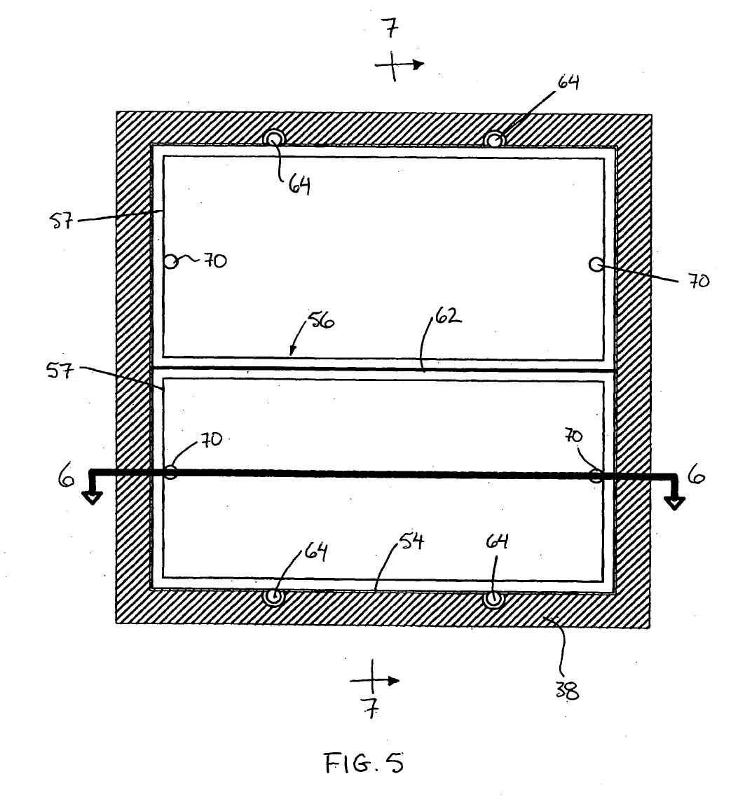

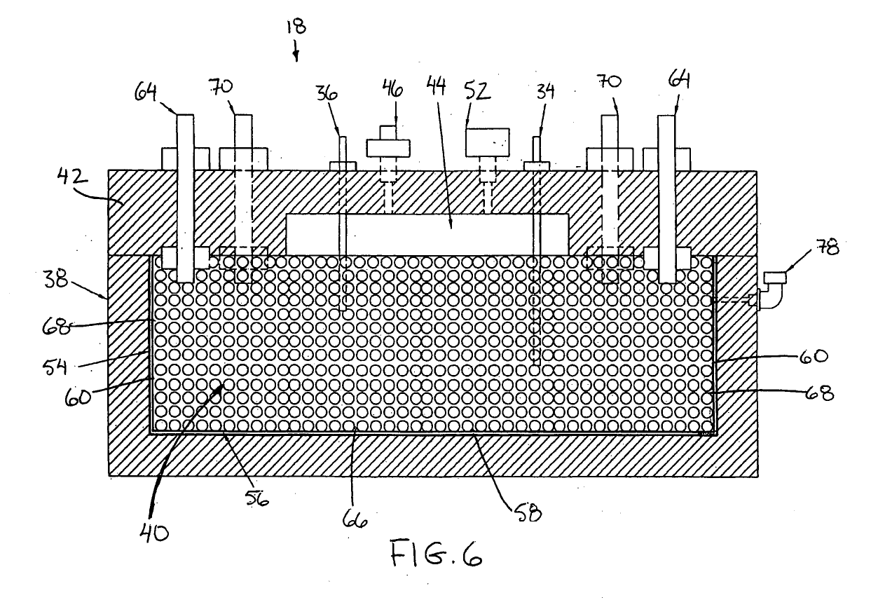

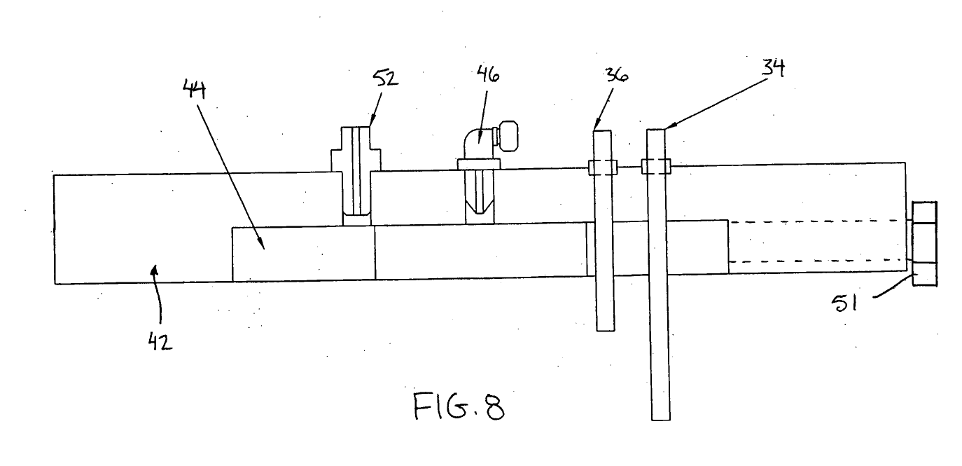

In the illustrated embodiments in FIGS. 4-10, the cell is shown with two units 57 forming the anode 56. However, as shown schematically in FIG. 2, three or more units 57 may be provided, in which case each unit 57 is associated with its own load switch 32 corresponding to a particular operating condition of the engine. Each of the units 57 forming the anode 56 are identical to one another and therefore are interchangeable as desired.

Similarly to the cathode 54, each unit 57 of the anode includes a working portion 66 in which the working portion comprises a flat rectangular member spanning horizontally adjacent and spaced directly above the working portion of the cathode 54. Each working portion 66 has suitable dimensions in the longitudinal and lateral directions so as to fit within one of the divided sections of the cathode as defined by the baffle portions 62.

Each unit 57 of the anode also includes a connecting portion 68 in the form of four generally upright walls extending upwardly from each of the four sides of the connecting portion so as to be joined with one another at the corners similarly to the connecting portions of the cathode. Due to the dimensions of the working portion 66 being slightly smaller than that of the cathode, the resulting position of the connecting portions 68 are spaced slightly inwardly from the connecting portions 60 of the cathode. Any welds which secure the connecting portions 68 together are maintained above the operating fluid level within the cell. When mounted in place, the anode units are nested within the cathode.

The units 57 of the anode also each include terminal connectors 70 extending upwardly from the connecting portions 68 respectively to extend upwardly through the cap for external connection to the power source. Each unit of the anode is provided with a pair of the terminal connectors 70 which extend upwardly from connecting portions 68 at opposed sides of the housing so as to be spaced apart from one another in a lateral direction at lateral ends of the housing in which the lateral direction is oriented perpendicular to the longitudinal direction of spacing of the terminal connectors 64 of the cathode.

Spacers 72 formed of insulating material, for instance UHMW plastic, are inserted between each anode unit and the cathode 54 to maintain a proper operating spacing therebetween. The spacers 72 are provided on all four sides of the anode units and between the bottom of the anode units and the bottom of the cathode as well. The spacers ensure that spacing at the bottom between the working portions 66 and 58 of the anode and the cathode respectively is narrower than the spacing between the connecting portions 68 and 60 towards the top end of the cell so that the anode and the cathode are nearest one another at the bottom of the cell at the broad surfaces of the working portions which are generally horizontal in orientation. Accordingly, the anode and cathode are spaced farther apart from one another adjacent the top end of the chamber. Spacing between the horizontal working portions of the anode and cathode is uniform throughout the cell.

In this arrangement as the fluid level drops, the majority of the electrolysis taking place is concentrated at the working portions of the anode and cathode which remain fully submerged as the fluid level in the cell may vary considerably so that the output of hydrogen and oxygen gas remains relatively consistent throughout the varying solution level.

The recess 44 formed within the underside of the cap 42 includes a main portion extending in the longitudinal direction of the housing in which the units 57 are sequentially aligned. At spaced positions along the main portion, the recess 44 also includes enlarged lobes 84 positioned centrally in alignment with each of the units 57 of the anode. The rounded shape forming the recess provides a cooling area which encourages precipitation of steam back down into the main portion of the chamber in the housing. The rounded shape complements communication between the gas outlet 46 and the engine being maintained in an uphill orientation with the precipitator 24 coupled in series therewith to further prevent any moisture from reaching the intake of the engine.

With reference to FIG. 2, the power source according to both embodiments is shown having three independent power supplies 74 corresponding in number to the number of units 57 of the anode so that each power supply 74 is associated with a respective unit 57 of the anode 56. Each of the power supplies 74 is charged by connection to a positive terminal of the alternator 16 driven by the engine. Each of the power supplies 74 is in turn connected to the respective anode through a respective control relay 76 of the controller 26.

In order to close the controller relays 76, the relays must be grounded which requires that the switch of the engine operating sensor 28 is closed responsive to the engine being turned on, that the safety switch 27 is closed responsive to the prescribed safety conditions being met and that the low fluid level sensor 34 is grounded within the electrolytic solution corresponding the fluid level being above the lower limit required for operation. Provided these conditions are met, a first one of the power supplies 74 is permitted to communicate with the first unit 57 of the anode to commence the production of gases.

Grounding of the second control relay 76 however requires that the mid-load switch 30 is also closed before the second control relay 76 is permitted to close and in turn permit power being delivered to the second unit 57 of the anode. Each subsequent power supply and unit of the anode requires that a subsequent load switch 32 be closed responsive to a further engine operating condition. In this manner, the cell 18 may be operated in various stages corresponding to different levels of production of hydrogen and oxygen gases for delivery to the engine intake.

The control relays 76 of the controller 26 serve to interrupt flow of power to different sections or units 57 of the anode so that the overall surface area of the anode is effectively reduced when certain units 57 are interrupted. Furthermore the overall amperage flowing through the cell is reduced when the units are interrupted due to interruption of the power supplies with the anode 56. Cutting off some of the power supplies reduces the overall voltage difference applied across the electrolytic solution which in turn reduces the amperage or current which is flowed through the solution to produce gas.

In order to refill the solution within the cell as it is consumed, a refill system is provided as described further below for either refilling the solution manually or automatically depending upon the configuration of the refill system. When the cell is full of solution, the solution reaches the high fluid level sensor 36 to make contact with the ground connection thereof and in turn provide a ground to an indictor relay 80 of the controller. The indicator relay 80 closes a switch which provides a ground to an indicator light 82 which provides an indication to the operator that the cell is full.

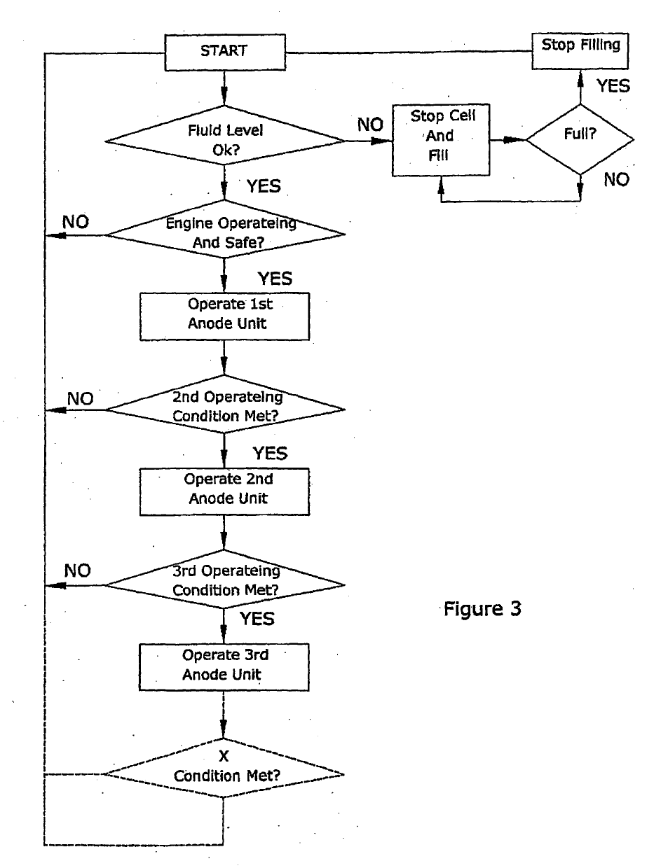

Turning now to FIG. 3, the operation of the system, according to either embodiment, is illustrated as a flow chart. Prior to operation, the system first ensures that the solution level within the cell is adequate otherwise power to the power supplies 74 of the power source 20 is interrupted and a fill cycle is initiated in which the cell is automatically filled or instructions are provided to the operator to fill the cell manually. Once full, the indicator light 82 provides indication that no further filling is required and continued operation is permitted.

The system subsequently ensures that the engine is operating using the engine operating sensor 28 and that the safety conditions of the safety switch 27 are met prior to grounding the power supply of the first unit 57 of the anode which begins the initial production of gases. The system continually monitors the engine operating conditions and fuel demand to determine if a mid-load engine operating condition has been met to determine if a subsequent power supply 74 should be connected to the respective unit 57 of the anode to both increase the surface area of the anode and increase the overall amperage delivered to the anode 56 collectively for increasing the production rate of the gas by the cell.

As further operating conditions are met, additional power supplies 74 are activated and connected to additional units 57 which are added onto the collective anode 56. The entire cathode 54 remains grounded and active throughout all of the operating conditions so that there is always a greater surface area of cathode than anode in operation.

By providing a common cathode 54 with multiple independently operated anode units 57 within a common fluid bath, failure of one cell does not affect operation of the other cells for optimizing efficiency and dependability of the system. The controller 36 may be electronic and may include options which permit rerouting of the connections between the units 57 of the anode and the respective relays associated with the mid-load and high-load switch so that a base operating one of the units 57 of the anode can be changed from one unit to another.

The construction of the anode and cathode as described herein is particularly advantageous when providing working portions nearest one another at the bottom of the chamber. The fluid levels can thus be maintained sufficiently high to fully cover the working portions even when the fluid level drops to 10% or less of the total volume of the cavity 40. The nearer spacing between the cathode and anode at the bottom of the cell thus provides a more consistent operation as the fluid level drops or varies due to vehicular motion.

As described above, both the cathode and anode are formed of stainless steel with an electroless nickel plating formed thereon in which the surface area of the cathode is in the range 20% larger than a combined surface area of the units 57 forming the collective anode 56.

Though the body and cap as described herein are formed of UHMW, any suitable insulating material, preferably plastic may be used where there is sufficient strength and sufficient resistance to the corrosive fluids in the engine environment. When forming the housing out of plastic, the housing is preferably surrounded by a full aluminium box which forms a solid jacket surrounding the housing and adding strength to resist any potential explosions within the cell.

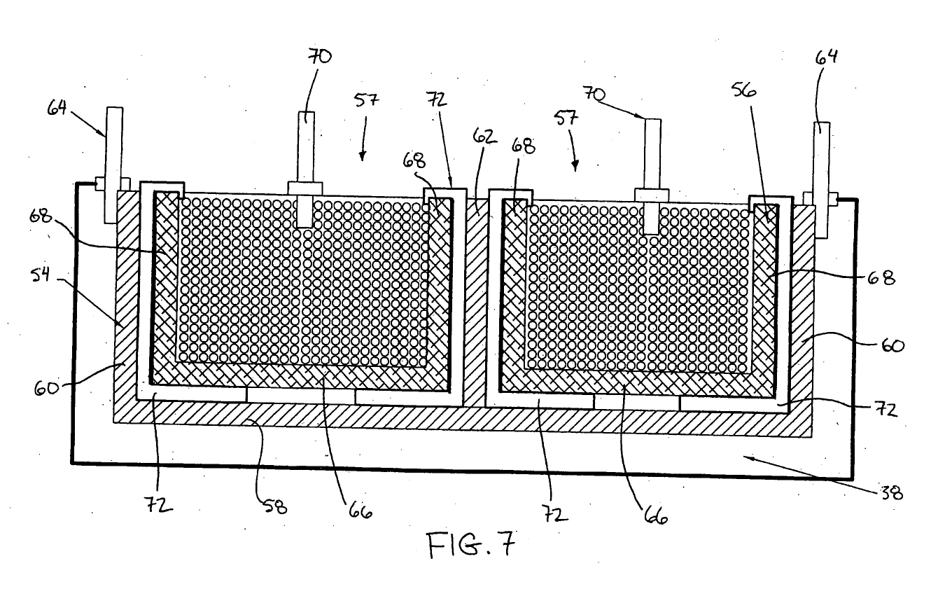

Turning now more particularly to the illustrated embodiment of FIGS. 4 through 9, the connecting portions 60 and 68 of the cathode and anode respectively are parallel as shown best in FIG. 7. In this exemplary embodiment this results in a consistent spacing of approximately five millimetres in a horizontal direction between the connecting portions of the anode units and the cathode. A narrower vertical spacing of approximately four millimetres between the working portion 66 of the anodes and the working portion of the cathode 58 is found to be satisfactory for concentrating the production of gases at the working portions of the anode and cathode adjacent the bottom of the cell.

Also as shown in the illustrated embodiment of FIGS. 4 through 9, the refill system for replenishing the solution in the cell comprises a fill spout 78. The fill spout 78 is provided on one side of the housing near the upper end of the body 38 for receiving the electrolyte solution therethrough and into the chamber with which the fill spout communicates. The fill spout 78 includes an open top end at a height which is generally in alignment with the desired or prescribed maximum fluid operating level within the housing so that attempts to overfill the cell will simply result in fluid spilling over the open top end of the spout 78 at the external side of the housing. A suitable cap is provided on the fill spout for selectively closing the spout as desired for operation.

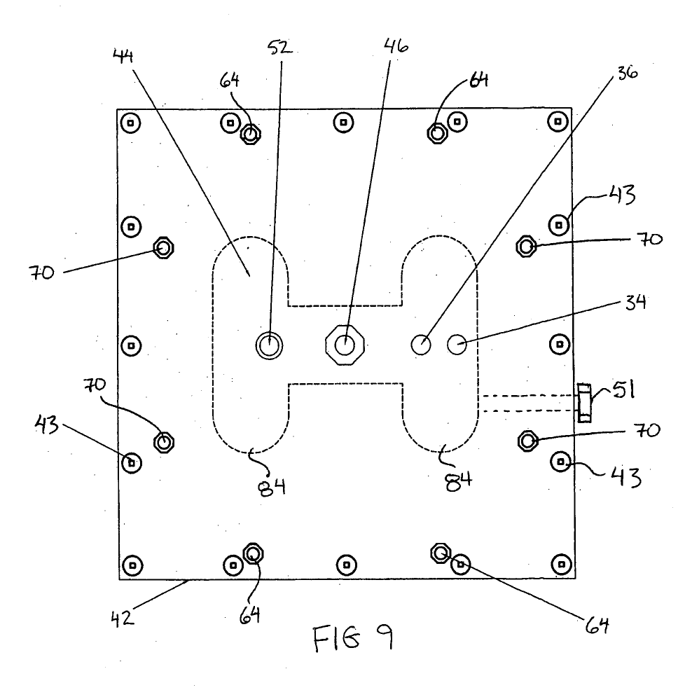

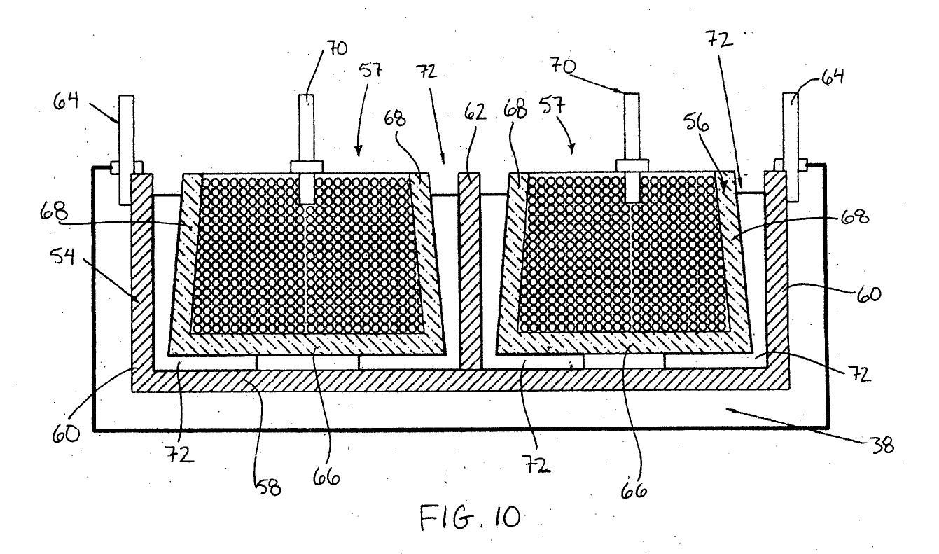

In an alternative embodiment of the anodes 56 as shown in FIG. 10, the connecting portions 68 of the anode may be trapezoidal in shape in relation to the respective working portions 66 such that the opposing connecting portions 68 of each anode are sloped inwardly towards one another with increasing spacing from the cathode with increasing distance from the bottom end towards the top end of the housing. In this configuration, the cathode and anode are farther apart from one another at the top end than at the bottom end with spacing between the cathode and anode gradually decreasing towards the horizontal working portions 58 and 66 of the anode and cathode respectively adjacent the bottom end of the housing. The production of gases is thus also concentrated at the working portions of the anode and cathode as in the previous embodiment.

In an alternative embodiment of the refill system, as shown in FIG. 11, the refill system automatically replenishes the solution in the cell. The refill system in this embodiment includes a refill reservoir 100 comprising an enclosed chamber having a volume which is near the volume of the chamber within the cell or which may be substantially greater in volume as desired. A fill cap 102 is provided at the top end of the chamber for access to the interior for refilling the reservoir 100 with water as required. The fill cap 102 includes a check valve formed therein so that cap is vented to allow air to be drawn into the chamber as required as the fluid level is depleted to prevent a vacuum pressure occurring in the reservoir. The fill cap 102 also includes a pressure relief coupled thereto to relieve pressure in the event of excess steam build up or the like.

A fluid conduit 104 is coupled between the chamber of the reservoir 100 and the chamber of the cell for feeding water from the reservoir 100 to the chamber in the cell therethrough as the solution in the cell is depleted during electrolysis. The fill conduit 104 feeds the fluid by gravity from the reservoir 100 which is positioned at greater elevation than the cell so that gravity alone is sufficient to cause the fluid to be dispensed from the reservoir to the cell.

An overflow fitting 105 is coupled to a side of the reservoir in communication with the fluid. The overflow fitting 105 ensures that fluid in the reservoir above a prescribed maximum fluid level is drained out of the reservoir so that sufficient clearance is provided in the reservoir at all time for expansion of the water if it freezes.

A water control valve 106 is coupled in series with the fluid conduit 104 for selectively shutting off the conduit and preventing overfilling of the chamber in the cell. The water control valve 106 is operated by the controller 26 of the system to be opened responsive to a fill cycle being initiated and for being closed responsive to the fluid level in the chamber of the cell reaching the maximum prescribed level as determined by the fluid level sensors in the cell. Only the water portion of the solution in the cell requires replenishing as the electrolyte is not consumed by electrolysis in the cell and accordingly the reservoir 100 is only filled with water. The water provided to the cell for mixture with the electrolyte comprises steam distilled, reverse osmosis, or some other filtered water and the like.

In order to prevent freezing of the water in the reservoir 100 and fill conduit 104, a coolant bypass duct 108 is provided for connection to the internal combustion engine in a manner to receive coolant fluid from the engine therethrough. The coolant bypass conduit 108 may be coupled in series or in parallel with the radiator of the coolant system of the engine. The coolant bypass conduit 108 includes a jacket portion 110 which fully surrounds the reservoir 100, a housing portion 112 supported adjacent the electrolytic cell and a main conduit portion 114 communicating between the jacket portion 110 and the housing portion 112.

The main conduit portion 114 fully surrounds the fill conduit 104 so that the fill conduit is received substantially concentrically through the main conduit portion of the coolant bypass conduit along a full length of the fill conduit. The jacket portion 114 includes a fluid inlet and a fluid outlet at spaced apart positions for connection in series with the remainder of the coolant bypass conduit for circulating the coolant from the engine through the jacket which fully surrounds the reservoir.

The housing portion 112 comprises an isolated chamber formed in the housing of the cell and separated from the main chamber containing the electrolytic solution therein. The housing portion 112 includes an inlet and an outlet coupled in series with the remainder of the coolant bypass conduit 108 for circulating the engine coolant therethrough. Although the housing portion 112 occupies a considerable portion of the cell in the illustrated embodiment of FIG. 11, the housing portion 112 is only required to be sufficiently large for surrounding the fitting which supports the fill conduit 104 in communication with the fluid in the chamber of the cell so as to keep the fitting from freezing in colder climates. A control can be mounted on the coolant bypass conduit to selectively shut off circulation of coolant therethrough if the coolant is too hot as it is undesirable for the cell to be operating at an unnecessarily high temperature for optimum efficiency.

In this configuration, the heat in the engine coolant circulated through the coolant bypass conduit is arranged to exchange heat with the refill reservoir 100, the fill conduit 104 and connection of the fill conduit 104 to the cell to prevent freezing of the water in the reservoir and the fill conduit 104 in colder climates. The coolant bypass conduit 108 is arranged to locate the housing portion 112 downstream of the main conduit portion 114 which is in turn downstream from the jacket portion 110 about the reservoir.

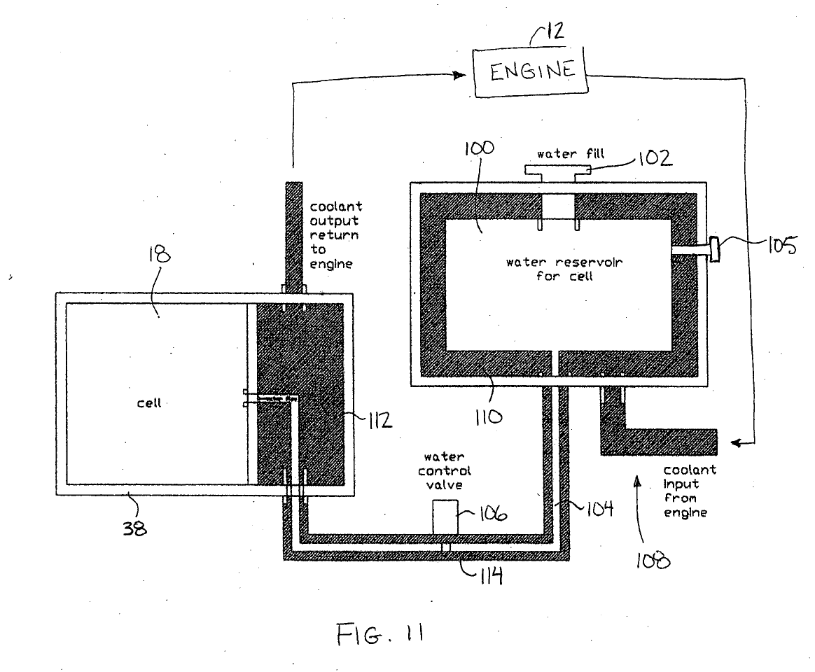

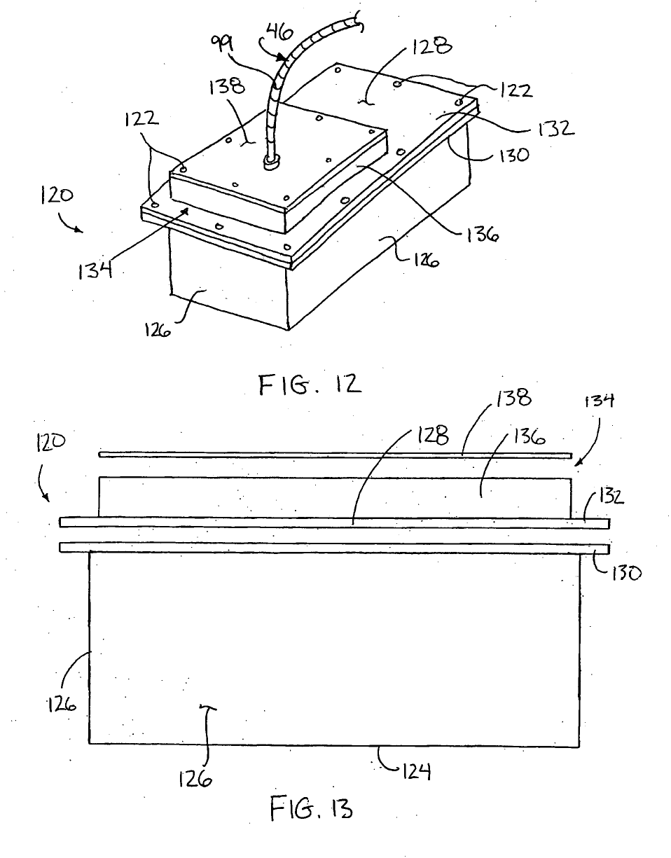

In addition to providing heat from the coolant bypass duct, use of electrical resistance heating wire is also possible to provide heat to various components of the cell. As shown in the embodiment of FIG. 12, a length of heat tape 99 is wrapped about the tube of the gas outlet 46 communicating between the cell and the intake of the engine to prevent freezing of any condensation formed therein. The heat tape 99 includes a suitable electrical resistance wire embedded therein to provide the heat while only drawing a very small amount of electricity from the vehicle.

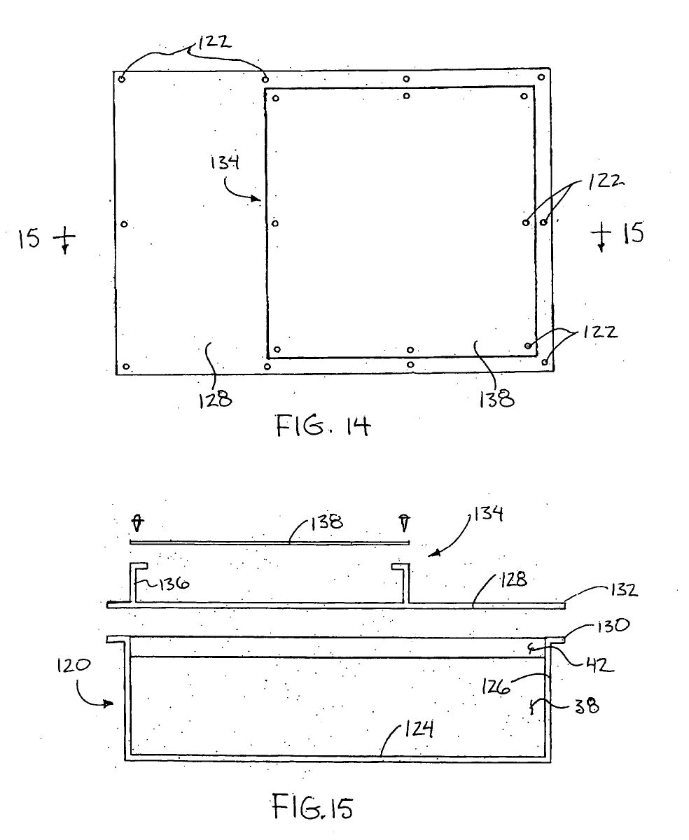

Turning now to FIGS. 12 through 15 in greater detail, a further embodiment of the housing is illustrated in which the body 38 and cap 42 are secured together by an exterior jacket 120 which clamps the cap to the body externally of the housing. In this instance no bolt apertures are formed through the body 38 or through the cap 42 as the body and cap are instead clamped together by bolts 122 which are mounted about the exterior of the housing between opposed portions of the jacket 120 which clamp the cap and body therebetween. The jacket includes a rectangular floor 124 which spans the bottom of the housing and four side walls 126 extending upwardly from the sides of the floor. The side walls 126 are joined with one another at the corners to form a receptacle which fully surrounds the bottom and sides of the housing.

The walls 126 of the jacket span the full height of the combined body 38 and cap 42 so that a flat top plate 128 may be mounted flush across the top of the walls 126 of the jacket while securing both the body 38 and cap 42 of the housing therein. The walls 126 include a peripheral mounting flange 130 about the periphery thereof which spans horizontally outward, parallel to the floor 124. The top plate 128 is suitably dimensioned to span to the outer peripheral edge of the mounting flange 130 about the full perimeter thereof so that a peripheral flange portion 132 is defined about the perimeter of the top plate 120 which projects laterally outwardly beyond the walls 126. The bolts 122 are thus secured between the mounting flange 130 of the walls and the flange portion 132 of the top plate forming the jacket 120. Clamping the mounting flange and flange portion together ensures that the top plate 128 and the floor 124 are clamped together with the body and cap of the housing therebetween.

A compartment 134 is formed on the outer side of the top plate 128 in the form of four protruding walls 136 in a rectangular configuration which are joined at respective corners and which are sealed with respect to each other and the top plate 128. A cover plate 138 is suitably sized to span the protruding walls 136 formed on the top plate 128 to enclose the compartment 134 opposite the plate 128 which forms the bottom of the compartment. The compartment 134 is suitably sized for receiving the controller 26 and the power source 20. All of the electrical components of the system are communicated from the controller through the top plate 128 directly into the cap 42. The gas, outlet also communicates upwardly through the compartment 134 and through the cover plate 138 thereof. The surrounding jacket 120 provides protection against explosions while also providing some additional protection against leaking electrolyte due to the walls of jacket spanning the seam between the main body 38 and the cap 42 of the housing.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An electrolyser system for producing combustion enhancing gas for an internal combustion engine, the system comprising:
an enclosed housing having a chamber for containing electrolyte solution;
an anode and a cathode supported spaced apart from one another in the chamber of the housing;
a gas conduit for conducting gas from the chamber of the housing to the engine;
a power source having opposed terminals for connection to the anode and cathode respectively; and
the cathode and the anode being nearest one another adjacent a bottom end of the chamber.

2. The system according to claim 1 wherein at least one of the anode and the cathode comprises a perforated member of steel having a nickel plating formed thereon.

3. The system according to claim 1 wherein both the anode and the cathode comprise a perforated member of steel having a nickel plating formed thereon.

4. The system according to any one of claims 1 through 3 wherein the cathode and the anode each comprise a working portion, the working portions spanning generally horizontally spaced above one another adjacent a bottom end of the chamber.

5. The system according to claim 4 wherein spacing between the working portions of the anode and the cathode is substantially uniform.

6. The system according to any one of claims 1 through 5 wherein the anode and the cathode are spaced farther apart from one another adjacent a top end of the chamber than adjacent the bottom end of the chamber.

7. The system according to any one of claims 1 through 6 wherein each anode and each cathode includes a working portion adjacent the bottom end of the chamber and a connecting portion extending upwardly from the working portion, the connecting portions of the anode and the cathode having increasing spacing therebetween with increasing distance from the bottom end of the chamber.

8. The system according to any one of claims 1 through 7 wherein each anode and each cathode includes a working portion spanning generally horizontally adjacent the bottom of the chamber and a connecting portion extending upwardly from each side of the working portion.

9. The system according to claim 8 wherein one of the anode and the cathode is nested within the other of the anode and the cathode and the connecting portions of an innermost one of the anode and the cathode are tapered inwardly towards one another.

10. The system according to any one of claims 1 through 9 wherein at least one of the anode and the cathode comprises a generally horizontal working portion adjacent the bottom end of the chamber and a connecting portion extending upwardly from the generally horizontal working portion and wherein the working portion is nearer to a portion of the opposed cathode or anode than the connecting portion.

11. The system according to any one of claims 1 through 10 wherein each of the anode and the cathode comprises a generally horizontal working portion adjacent the bottom end of the chamber and a plurality of connecting portions extending between the power source and the working portion, the connecting portions being connected to the working portion at opposed ends of the working portion.

12. The system according to any one of claims 1 through 11 wherein each of anode and the cathode comprises a generally horizontal working portion adjacent the bottom end of the chamber and a connecting portion anchored between the working portion and a top end of the chamber.

13. The system according to any one of claims 1 through 12 wherein the chamber comprises a seamless bottom and side walls enclosed at a top end by a cap, the anode and the cathode communicating with the power source through the cap.

14. The system according to any one of claims 1 through 13 wherein a working surface area of the cathode is greater than a working surface area of the anode.

15. The system according to any one of claims 1 through 14 wherein a working surface area of the cathode is at least 20% greater than a working surface area of the anode.

16. The system according to any one of claims 1 through 15 wherein there is provided at least one baffle supported in the chamber of the housing in an upright orientation to span opposing side walls of the chamber, the baffle including apertures for communication of the electrolyte solution in the chamber therethrough.

17. The system according to any one of claims 1 through 16 wherein there is provided at least one fluid level sensor supported within the chamber for detecting a fluid level of the electrolyte solution in the chamber, said at least one fluid level sensor being arranged to detect a level of the fluid reaching a prescribed limit by detecting connection and disconnection of a ground connection of the level sensor with the electrolyte solution.

18. The system according to claim 17 wherein the chamber comprises a seamless bottom and side walls enclosed at a top end by a cap, said at least one fluid level sensor communicating with the electrolyte solution through the cap.

19. The system according to claim 17 or 18 wherein said at least one fluid level sensor is centrally supported within the chamber.

20. The system according to any one of claims 1 through 19 wherein there is provided a low fluid level sensor supported within the chamber adjacent a lower prescribed limit of the chamber, the low fluid level sensor being arranged to detect a level of fluid reaching the prescribed limit by detecting disconnection of a ground connection of the low fluid level sensor with the electrolyte solution in the chamber.

21. The system according to any one of claims 1 through 20 wherein there is provided a high fluid level sensor supported within the chamber adjacent an upper prescribed limit of the chamber, the high fluid level sensor being arranged to detect a level of the fluid reaching the prescribed limit by detecting connection of a ground connection of the high fluid level sensor with the electrolyte solution in the chamber.

22. The system according to any one of claims 1 through 21 wherein there is provided a safety switch arranged to interrupt connection of the power source to at least one of the anode and the cathode responsive to an abnormal orientation of the engine.

23. The system according to any one of claims 1 through 22 wherein there is provided a coolant bypass conduit for connection to the internal combustion engine to receive coolant fluid from the engine therethrough, the coolant bypass conduit being coupled to the housing for exchanging heat between the housing and the coolant fluid received through the coolant bypass conduit.

24. The system according to any one of claims 1 through 23 wherein there is provided a refill reservoir coupled to the chamber for replenishing the electrolyte solution in the chamber from the refill reservoir and a coolant bypass conduit for connection to the internal combustion engine to receive coolant fluid from the engine therethrough, the coolant bypass conduit being coupled to the refill reservoir for exchanging heat between the refill reservoir and the coolant fluid received through the coolant bypass conduit.

25. The system according to any one of claims 1 through 24 wherein there is provided a refill reservoir coupled to the chamber by a fill conduit for replenishing the electrolyte solution in the chamber from the refill reservoir through the fill conduit and a coolant bypass conduit for connection to the internal combustion engine to receive coolant fluid from the engine therethrough, the coolant bypass conduit being coupled to the fill conduit for exchanging heat between the fill conduit and the coolant fluid received through the coolant bypass conduit.

26. The system according to claim 25 wherein the coolant bypass conduit surrounds the fill conduit such that the fill conduit is received substantially concentrically through the coolant bypass conduit along a length of the fill conduit.

27. The system according to any one of claims 1 through 26 wherein there is provided a fill spout coupled to the housing for receiving electrolyte solution therethrough to fill the chamber to a prescribed maximum fluid operating level, the fill spout including an open top end which is selectively enclosed by a cap, the open top end being at a height which is substantially in alignment with the prescribed maximum fluid operating level.

28. The system according to any one of claims 1 through 27 wherein the housing is arranged for mounting below an intake of the engine such that the gas conduit extends continuously upward from the housing to the engine intake.

29. The system according to any one of claims 1 through 28 wherein the power source comprises an amperage control for adjusting amperage supplied to the anode and cathode.

30. The system according to claim 29 wherein the amperage control is arranged to adjust amperage responsive to fuel demands by the engine.

31. The system according to claim 29 wherein the amperage control is arranged to adjust amperage responsive to varying pressure in a turbocharger of the engine.

32. The system according to any one of claims 29 through 31 wherein the power source comprises a plurality of independent power supplies and the control is arranged to connect and disconnect the power supplies with at least one of the anode and the cathode independently of one another for adjusting amperage supplied to the cathode and the anode.

33. The system according to claim 32 wherein there is provided a load sensing switch for connection to the engine to determine a prescribed operating condition of the engine corresponding to increased fuel demands by the engine, at least one of the power supplies only being connected to both the anode and the cathode responsive to determination of the prescribed operating condition by the load sensing switch.

34. The system according to claim 33 wherein there is provided a plurality of load sensing switches connected to the engine to determine respective prescribed operating conditions of the engine, each prescribed operating condition corresponding to a different fuel demand by the engine, the load sensing switches being associated with respective ones of the power supplies which are only connected to both the anode and the cathode responsive to determination of the prescribed operating condition by the associated load sensing switch.

35. The system according to any one of claims 1 through 34 wherein the power source comprises an amperage control for adjusting amperage supplied to the anode and cathode, the control being arranged to vary a submerged surface area of at lease one of the cathode and the anode across which the voltage is applied for adjusting amperage supplied to the cathode and the anode.

36. The system according to claim 35 wherein said at least one of the cathode and the anode comprises a plurality of independent units and the control is arranged to vary a submerged surface area of said at least one of the cathode and the anode by connecting and disconnecting the independent units with the power source independently of one another.

37. The system according to any one of claims 1 through 36 wherein at least one of the cathode and the anode comprises a plurality of independent units and the power source comprises a plurality of independent power supplies associated with the independent units respectively, and wherein there is provided a control for selectively connecting and disconnecting the plurality of independent power supplies with respective ones of the plurality of independent units of said at least one of the cathode and the anode for adjusting amperage supplied to the anode and cathode.

38. The system according to any one of claims 1 through 37 wherein the anode comprises a plurality of independent units coupled to respective independent power supplies of the power source and the cathode comprises a common unit spanning the plurality of independent units of the anode.

39. The system according to any one of claims 1 through 38 wherein at least one of the anode and the cathode comprises a plurality of independent units coupled to the power source independently of one another and wherein there is provided a control for coupling the independent units to the power source responsive to a prescribed operating condition of the engine.

40. The system according to any one of claims 1 through 39 wherein at least one of the anode and the cathode comprises a plurality of independent units and wherein the power source comprises a plurality of independent power supplies coupled to the independent units respectively, connection of each unit with the respective power source being responsive to a prescribed operating condition of the engine.

41. The system according to any one of claims 1 through 40 wherein at least one of the anode and the cathode comprises a plurality of independent units supported commonly within the chamber of the housing.

42. The system according to any one of claims 1 through 41 wherein at least one of the anode and the cathode comprises a plurality of independent units which are identical in configuration with one another so as to be interchangeable.

43. An electrolyser system for producing combustion enhancing gas for an internal combustion engine, the system comprising:
an enclosed housing having a chamber for containing electrolyte solution;
an anode and a cathode supported spaced apart from one another in the chamber of the housing;
a gas conduit for conducting gas from the chamber of the housing to the engine;
a power source having opposed terminals for connection to the anode and cathode respectively; and
an amperage control for adjusting amperage supplied by the power source to the anode and cathode.

44. The system according to claim 43 wherein the amperage control is arranged to adjust amperage responsive to fuel demands by the engine.

45. The system according to claim 43 wherein the amperage control is arranged to adjust amperage responsive to varying pressure in a turbocharger of the engine.

46. The system according to any one of claims 43 through 45 wherein the power source comprises a plurality of independent power supplies and the amperage control is arranged to connect and disconnect the power supplies with at least one of the anode and the cathode independently of one another for adjusting amperage supplied to the cathode and the anode.

47. The system according to claim 46 wherein there is provided a load sensing switch for connection to the engine to determine a prescribed operating condition of the engine corresponding to increased fuel demands by the engine, at least one of the power supplies only being connected to both the anode and the cathode responsive to determination of the prescribed operating condition by the load sensing switch.

48. The system according to claim 47 wherein there is provided a plurality of load sensing switches connected to the engine to determine respective prescribed operating conditions of the engine, each prescribed operating condition corresponding to a different fuel demand by the engine, the load sensing switches being associated with respective ones of the power supplies which are only connected to both the anode and the cathode responsive to determination of the prescribed operating condition by the associated load sensing switch.

49. The system according to any one of claims 43 through 48 wherein the power source comprises an amperage control for adjusting amperage supplied to the anode and cathode, the control being arranged to vary a submerged surface area of at least one of the cathode and the anode across which the voltage is applied for adjusting amperage supplied to the cathode and the anode.

50. The system according to claim 49 wherein said at least one of the cathode and the anode comprises a plurality of independent units and the control is arranged to vary a submerged surface area of said at least one of the cathode and the anode by connecting and disconnecting the independent units with the power source independently of one another.

51. The system according to any one of claims 43 through 50 wherein at least one of the cathode and the anode comprises a plurality of independent units and the power source comprises a plurality of independent power supplies associated with the independent units respectively, and wherein there is provided a control for selectively connecting and disconnecting the plurality of independent power supplies with respective ones of the plurality of independent units of said at least one of the cathode and the anode for adjusting amperage supplied to the anode and cathode.

52. The system according to any one of claims 43 through 51 wherein the anode comprises a plurality of independent units coupled to respective independent power supplies of the power source and the cathode comprises a common unit spanning the plurality of independent units of the anode.

53. The system according to any one of claims 43 through 52 wherein at least one of the anode and the cathode comprises a plurality of independent units coupled to the power source independently of one another and wherein there is provided a control for coupling the independent units to the power source responsive to a prescribed operating condition of the engine.

54. The system according to any one of claims 43 through 53 wherein at least one of the anode and the cathode comprises a plurality of independent units and wherein the power source comprises a plurality of independent power supplies coupled to the independent units respectively, connection of each unit with the respective power source being responsive to a prescribed operating condition of the engine.

55. The system according to any one of claims 43 through 54 wherein at least one of the anode and the cathode comprises a plurality of independent units supported commonly within the chamber of the housing.

56. The system according to any one of claims 43 through 55 wherein at least one of the anode and the cathode comprises a plurality of independent units which are identical in configuration with one another so as to be interchangeable.
